(19) United States
(12) Patent Application Publication
(10) Pub. No.: US 2018/0293054 A1
(43) Pub. Date: Oct. 11, 2018

(54) Method of selecting mobile device models for application development on basis of user operational profiles

(71) Applicant: Peking University, Beijing (CN)

(72) Inventors: Xuanzhe Liu, Beijing (CN); Gang Huang, Beijing (CN); Hong Mei, Beijing (CN); Xuan Lu, Beijing (CN); Huoran Li, Beijing (CN)

(21) Appl. No.: 15/746,450

(22) PCT Filed: Sep. 7, 2016
(86) PCT No.: PCT/CN2016/098290

§ 371 Date: Jan. 22, 2018

(30) Foreign Application Priority Data
Dec. 28, 2015 (CN) 2015110009401

(51) Int. Cl. G06F 8/10

(52) U.S. Cl. CPC G06F 8/10

(57) ABSTRACT

The present invention discloses a method for selecting mobile device models for application development based on user operational profiles. The method includes: 1) selecting a target application for predicting importance of the device models; 2) the user data of the target application does not meet a preset condition, proceeding to step 3); if the preset condition is met, determining importance of mobile device models for the target application according to operational profile record for the target application, and ranking the device models according to the importance, then proceeding to step 5); 3) selecting a set of applications associated with the largest number of users in an application category to which the target application belongs; 4) determining importance of the device models using the target application according to the user operational profile of the set of applications selected in step 3), and ranking each device model according to the associated importance; and 5) selecting a plurality of device models to be used for the target application according to the priority ranking. The present invention greatly improves accuracies of device predictions.

### TECHNICAL FIELD

The present invention relates to a method of selecting mobile device models for application development based on user operational profiles, which belongs to the technical field of software and is suitable for the development and testing of mobile applications.

### BACKGROUND OF THE INVENTION

In recent years, with the popularization of smartphones and tablets, mobile applications have made rapid progress. In 2015, millions of mobile applications can be downloaded from application stores with billions of downloads. A lot of mobile application developers have benefited from it.

Compared to the relatively fixed iOS device model and the Windows operating system, the Android platform has open-source and flexible features, which has allowed it to be adopted by a large number of equipment manufacturers, but has also brought serious fragmentation problems for Android devices. According to reports at Android review sites OpenSignal, as of 2014, more than 20,000 model types are available for Android devices. Device fragmentation creates challenges for the design, development, maintenance, and operation of mobile applications. For example, developers need to consider the equipment factors such as screen size, resolution, and other hardware configuration when developing applications. Applications run with ease on high-end models may not run at all on low-end models. In order to cover as many users as possible, developers need more testing and quality management to guarantee application availability. If all models are not distinguished, the workload that developers need to bear will be extremely large.

Due to the seriousness of the Android fragmentation problem and resource constraints the application developer can generally focus on only a small portion of the large number of device models. At present, the common practice is to choose several device models that have the largest market shares based on Android device market share report released by major review sites. But this approach is really unreliable. In fact, market share can only reflect the numbers of various device models sold, but does not reflect actual usages. More importantly, the market share of a device model is not necessarily related to a specific application. For example, certain applications may be very popular in niche models, but not much used on popular models. On the other hand, even if an application is installed in a model, it may not necessarily be frequently used.

For application developers, the importance of different device models is reflected in whether to bring more users, activity, and advertising revenue and so on. To make accurate judgments on the importance of a device model, developers need to know how applications are actually used on different models. If the importance of the severely fragmented device models can be ranked for the application, limited resources can be better spent on optimizations on the important device models, also used to make applications more profitable. For example, for in-app advertising, a precise ad serving strategy should consider device models, and use it as a reference to determine the target delivery crowd.

### SUMMARY OF THE INVENTION

In view of the existing technical problems, the present invention proposes a method for selecting a mobile device model for application development based on user operational profiles. The more an application is used on a mobile device model, the more important this device model is to this application. The idea is related to the concept of operational profile in the operation configuration in software reliability engineering field. Operational profile is a widely adopted concept in software engineering, especially in software reliability engineering and software testing. It reflects how users use a system, in particular, the probability of different functions and the distribution of different parameter values. This description of the user behavior may be used to generate test cases, which are the most used functions in testing. Operational profile can help to enhance the communications between developers and users, allowing developers to think more about the product features and features that users are actually concerned about. Accordingly, using the concept of operational profile to screen the importance of different device models for different applications, allows developers to understand what device models are used by most users, so as to put more tests, optimization, operation resources on these device models.

The core idea of the invention is achieved by mining user operational profile data, analyzing actual usages of applications on different device models, thereby providing the order of importance of each device model for the specific application. For newly released or non-released applications (which lack user data), the disclosed method adopts collaborative filtering, namely, using device model ranking of applications of the same type as the prediction. Using real data set, this prediction method is validated to have high accuracy.

In order to reflect how much the user uses the application, the type of the operation in the operational profile record can be selected according to the actual situation. “Foreground use time” means the time a user interacts with an application. The longer foreground use time indicates that the users use this application for longer time. In the present invention, the “foreground use time” by users on different device models is used as an example to measure the importance of the different device models, thereby giving priorities to the device models.

The technical implementations of the present invention are as follows:

A method for selecting mobile device models for application development based on user operational profiles. The operational profile contains a variety of records, wherein the “foreground use time” is used as an example for illustrating the concept. Specific steps can include:

1) selecting a target application that needs predictions of importance of device models;

2) if the target application does not have sufficient user data, then the next step; otherwise analyzing operational profile of the user to produce priorities of various device models, the method ends. The detailed steps can include:
a) selecting the“foreground use time” records that users use the target application;
b) summing the foreground use times to a total time for each device model; and
c) sorting the device models in a descending order according to respective total times of the device models, which gives a first priority ranking;

3) in the application category in which the target application is located, selecting a set of applications associated with the largest number of users;

4) analyzing the operational profiles of the set of application selected in step 3) to produce a second priority ranking for the device models. The detailed steps can include:
a) selecting the“foreground use time” records that users use the set of applications;
b) summing the foreground use times to a total time for each device model regardless of applications; and
c) sorting the device models in a descending order according to respective total times of the device models, which produces the second priority ranking, and

5) predicting a priorities of the device models for the target application using the first or the second priority ranking.

The present invention includes two core technical points: firstly, using collaborative filtering, which uses mobile device priority order of already released applications as a reference for a new application in a same category; secondly, using operational profile to analyze which mobile device models are more important to a specific application. There can be a variety of metrics for the operational profile, including a ratio of install number to the uninstall number, foreground/background networking time (Wi-Fi), foreground/background networking time (3G/4G), foreground/background traffic (Wi-Fi), foreground/background data (3G/4G), and so on. The present invention is not limited to a specific metric for operational profile. “Foreground use time” is described only as an example for the disclosed method. When selecting different metrics, the subsequent processing techniques can be similar, but need to be adjusted according to the semantics of metrics. For example, when the metric of the ratio of install times to uninstall times is selected, the ratio is calculated after respectively summing all the installs and uninstalls of the target application for different device models.

The present invention has the following positive effects compared to the conventional technologies:

The present invention is carried out by mining user operational profile data, analyzing the actual usage of applications on different mobile device models, thereby providing priorities for different device models for the specific application. For newly released or non-released applications (which lack user data), the application of the present invention adopts the approach of collaborative filtering to predict priorities of mobile device models using those for an application of a same type. The present invention can greatly improve accuracies of device predictions.

### BRIEF DESCRIPTION OF THE DRAWINGS

FIG. 1 is a flowchart for the method of the present invention.

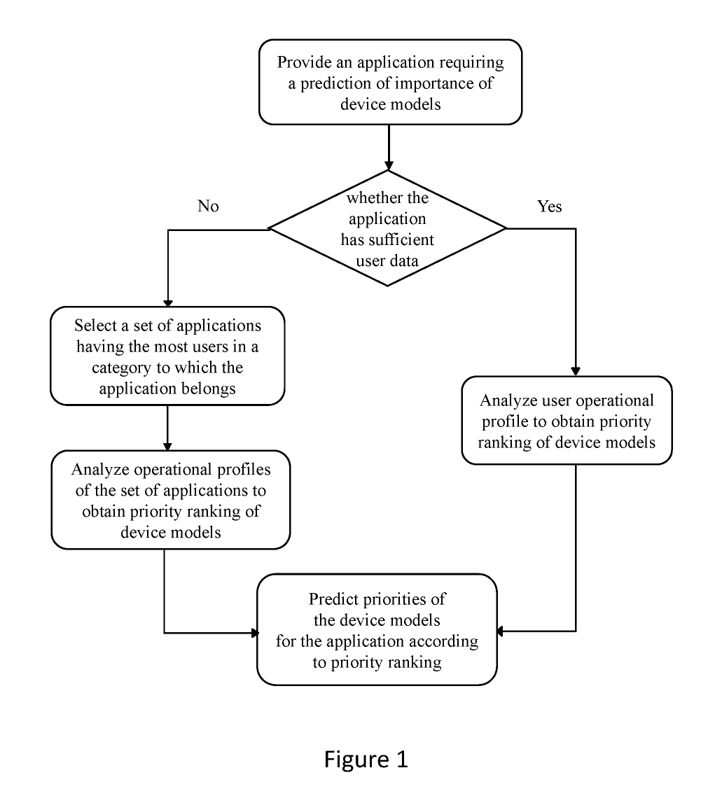

### DETAILED DESCRIPTION OF IMPLEMENTATIONS

The present invention is illustrated by the following example. Given a RGP (role playing game) game application A, the application is not yet released. It is necessary to predict which device models users spend more time using the application A, that is, to prioritize the device types. The method is as follows:

1) finding a few RGP game applications that already exist on the market, which belong to the same category as application A;

2) obtaining the user's operational profiles of these applications and selecting “foreground use time” records of these applications;

3) summing the foreground use time to a total time for each of the device models regardless of these applications;

4) ranking the device models in a descending order in accordance with total times associated with the respective device models; and

5) predicting priorities of the mobile device models for application A according to the ranking obtained in the previous step.

A method is disclosed for selecting mobile device models for application development based on user operational profiles. The user operational profile contains a variety of records. Among them, the ratio of install and uninstall numbers is used as an example. The specific steps include:

1) selecting the target application that needs to predict the importance of device models;

2) if the target application does not have sufficient user data, then proceeding to the next step in 3); otherwise, analyzing user operational profiles to obtain priority ranking for various device models. The specific steps include: selecting user install times and uninstall times of the target application from the user operational profiles; summing the install and uninstall times separately for each device model; and determine the importance of each mobile device for the target application using a ratio of install number to uninstall number of the target application for the device model;

3) selecting a set of applications associated with a largest number of users in a application category to which the target application belongs;

4) analyzing the operational profiles of step 3) of the set of applications to obtain the priorities of the device models. The detailed steps can include: selecting install and uninstall numbers of the set applications from the user operational profiles; summing the install and uninstall numbers separately for each of the device models; determining the importance for each of different device models for the target application according to a ratio of the summed install and uninstall numbers; and

5) predicting priorities of device models for the target application according to the priority ranking obtained in the previous steps.

What is claimed is:

1. A method for selecting mobile device models for application development based on user operational profiles, comprising:
1) selecting a target application that needs to predict the importance of device models;
2) if the target user data does not meet the set condition, proceed to step 3); if the set condition is met, determining importance of the device models using the target application according to the user operational profile of the target application, and sorting the device models according to the importance to produce a first priority ranking, and proceeding to step 5);
3) selecting a set of applications associated with a largest number of users in a application category to which the target application belongs;
4) determining importance of the device models using the target application according to the user operational profile of the set of applications selected in step 3), and sorting the device models to produce a second priority ranking according to the importance; and
5) selecting a plurality of device models to be used for the target application according to the first priority ranking or the second priority ranking.

2. The method of claim 1, wherein the importance of the device models for using the target application are determined according to foreground use times in the user operational profile, wherein the foreground use time refers to the time that a mobile device used by a user interacts with the target application.

3. The method of claim 2, wherein in step 2), the step of determining importance of the device models using the target application further comprises:
selecting foreground use time records of using the target application from the user operational profile;
summing the foreground use time to a total time for each of the device models; and
determining the importance of the device models according to total times associated with the respective device models.

4. The method of claim 2, wherein in step 4), the step of determining importance of the device models using the target application further comprises:
selecting the“foreground use time” records that users use the set of applications from the user operational profiles of the set of applications;
summing the foreground use times to a total time for each of the device models, regardless of applications in the the set of applications; and
determining the importance of the device models according to total times associated with the respective device models.

5. The method of claim 1, wherein the importance of each device model using the target application is determined according to a ratio of an install number to an uninstall number of the target application in the user operational profile.

6. The method of claim 5, wherein in the step 2) the number of times that the users install and uninstall the target application is selected from the user operational profiles, wherein numbers of times of install and uninstall are respectively summed for different device models, wherein the importance for each of different device models for the target application is determined according to a ratio of the summed install and uninstall numbers.

7. The method of claim 5, wherein in the step 4) the number of times that the users install and uninstall the set of applications is selected from the user operational profiles, wherein numbers of times of install and uninstall are respectively summed for different device models, wherein the importance for each of different device models for the set of applications is determined according to a ratio of the summed install and uninstall numbers.

8. The method of claim 1, wherein the importance of each of the device models using the target application is determined according to the foreground/background networking time in the user operational profile.

9. The method of claim 1, wherein the importance of each of the device models using the target application is determined according to the foreground/background traffic in the user operational profile.
